(19) United States
(12) Patent Application Publication
(10) Pub. No.: US 2013/0232070 A1
(43) Pub. Date: Sep. 5, 2013

(54) SYSTEMS AND METHODS FOR VALIDATING MONETARY TRANSACTION USING LOCATION INFORMATION OF A USER

(71) Applicant: DINESH SHARMA, New Delhi (IN)

(72) Inventor: DINESH SHARMA, New Delhi (IN)

(21) Appl. No.: 13/572,615

(22) Filed: Aug. 11, 2012

(30) Foreign Application Priority Data
Mar. 1, 2012 (IN) 587/DEL/2012

(51) Int. Cl. G06Q 20/40

(52) U.S. Cl. 705/44

(57) ABSTRACT

The present invention in a preferred embodiment provides systems and methods for validating monetary transaction using location information of a user, wherein the system comprises,
a) a transaction validation server;
b) a location information server;
c) a data input device; and
d) a processing mechanism;
   wherein, a user shall provide transaction information using the data input device and geographical location information of the data input device which is stored in the location information server shall be compared against a geographical location information of a pre-registered user-owned electronic device, and wherein the geographical location information of a pre-registered user-owned electronic device is also stored in the location information server and based on the comparative results of the processing mechanism the transaction validation server shall validate or invalidate a monetary transaction.

### BACKGROUND OF THE INVENTION

Electronic commerce (e-commerce) and/or online transactions, and/or accessing ATM (automatic teller machines), through usage of ATM cards/ debit cards, and/or credit cards, are now a common practice. Regular transactions involve an electronic payment made by a first party to a second party, for example, to purchase goods or services; or payment made by a first party to a second party using credit cards or debit cards for example, to purchase goods or services; or use of ATM terminals to withdraw money from a bank/finance house. In case of the electronic payments, an electronic payment is typically affected by the first party providing payment information (e.g., credit card information or debit card information or banking information) using an electronic device or a data input device connected to a network. Processes pertaining to an online transaction, which is being attempted to be made, include the providing of account/ card information, transmission of this information in encrypted form over a public computer network (e.g., the Internet) and/or a financial network to different computers (e.g., a payment gateway, an acquiring bank's processor, a card issuing bank's server) in order to validate or invalidate the online transaction and the information provided. Validation or invalidation of the online transaction is communicated to the first party via electronic device of the user. If validated, settlement of the online transaction takes place between the first party's bank or card issuing bank and the second party's acquiring bank.

In case a debit card or credit card or information linked to a debit card or credit card or banking information, is stolen or hacked, the thief or the hacker may use this information to use the debit card or credit card for monetary transaction without authorization of the owner.

Hence there is a requirement of a system and method which shall validate monetary transactions, as mentioned hereinabove, one of the ways of which is using an identification factor linked to the geographical location information of a user, which is addressed and employed by the present invention.

### OBJECTS OF THE INVENTION

The object of the invention is to provide systems and methods for validating monetary transaction using location information of a user.

### SUMMARY OF THE INVENTION

The present invention in a preferred embodiment provides systems and methods for validating monetary transaction using location information of a user, wherein the system comprises,
a) a transaction validation server;
b) a location information server;
c) a data input device; and
d) a processing mechanism;
   wherein, a user shall provide transaction information using the data input device and geographical location information of the data input device which is stored in the location information server shall be compared against a geographical location information of a pre-registered user-owned electronic device, and wherein the geographical location information of a pre-registered user-owned electronic device is also stored in the location information server and based on the comparative results of the processing mechanism the transaction validation server shall validate or invalidate a monetary transaction.

In an embodiment of the invention, the geographical location information of a data input device or a pre-registered electronic device may be updated at anytime either in present or in future or may be updated in a real-time basis.

In an embodiment of the invention, the pre-registered user-owned electronic device shall include any electronic device which has been registered for the purpose of validating monetary transaction in accordance with the present invention.

In an embodiment of the invention, a method for validating monetary transaction using location information of a user, comprises the steps of,
a) providing transaction information by a user using a data input device;
b) retrieving or relaying geographical location information of the data input device from the stored information in the location information server;
c) retrieving or relaying geographical location information of a pre-registered user-owned electronic device;
d) storing of geographical location information of the data input device in the location information server;
e) storing of geographical location information of the pre-registered user-owned electronic device in the location information server;
f) matching the retrieved geographical location information of the data input device with the retrieved geographical location information of the pre-registered user-owned electronic device by a processing mechanism; and
g) validating or invalidating a monetary transaction by a transaction validation server based on the comparative result of the geographical location information of the data input device and the pre-registered user-owned electronic device;
   wherein the data input device and the pre-registered user-owned electronic device may be same or different.

For the purpose of this invention, the ‘data processing mechanism’ shall involve computing, processing, comparing or analyzing information or data or metadata associated with a geographical location available within the system using one or more of a pre-defined algorithms or protocols for sorting or processing information from the data stored in the data storage device. The pre-defined algorithms or protocols or logic interprets and executes instructions for processing geographical location information and may be implemented by using any know or new micro-processors, mini- or mainframe computers or even plurality of such processors operating in parallel or as a pipeline. Algorithms or protocols or logic may be used for functions comprising of one or more of:

a) sorting or matching or mapping or comparing geographical location information;

b) locating or identifying geographical location information of a data input device and/or location information of a pre-registered user-owned electronic device within the stored data or information in the data storage device or with information available on one or more networking systems;

c) isolating or extracting matching data or information or request;

d) categorising or indexing or ranking of data or information associated with a geographical location; or a combination thereof.

In an embodiment of the invention, the functions performed by the data processing mechanism such as sorting or matching; locating or identifying; isolating or extracting; categorising or indexing or ranking may be optionally performed independent of one another.

Preferably, said pre-registered user-owned electronic device is a mobile device.

Alternatively, said pre-registered user-owned electronic device is a mobile phone device.

Alternatively, said pre-registered user-owned electronic device is a pre-registered computing device.

Alternatively, said pre-registered user-owned electronic device is an electronic device adapted to relay its real-time geographic location information, by itself, or upon querying.

Alternatively, said pre-registered user-owned electronic device is selected from a group of pre-registered user-owned electronic devices consisting of passive devices, active devices, or smart devices.

Alternatively, said system comprises a reader adapted to read signals from said pre-registered user-owned electronic device.

Alternatively, said pre-registered user-owned electronic device is a device with an embedded map-related application.

Typically, said system comprises a retrievable database adapted to store registration information comprising at least a device identity along with a correlated user identity.

Typically, said system comprises a location information server adapted to remotely communicate with said pre-registered user-owned electronic device in order to receive or retrieve its real-time location, said geographical location information server being adapted to communicate with said processing mechanism.

Typically, said system comprises a geographical location information server adapted to store location information of data input device, adapted to be used by said user to transact, said geographical location information server being adapted to communicate with said processing mechanism.

Typically, said system comprises a geographical location information server adapted to store location information of pre-registered user-owned electronic device, adapted to be used by said user to transact, said location information server being adapted to communicate with said processing mechanism.

Alternatively, said system comprises a geographical location information server adapted to receive or retrieve geographical location information of data input device adapted to be used by said user to transact, said geographical location information server being adapted to communicate with said processing mechanism.

Typically, said processing mechanism comprises comparators adapted to compare said real-time pre-registered user-owned electronic device location with said location of said data input device location where transaction is to be initiated in order to provide a confirmation of match in the event that said user, with said pre-registered electronic device, is within a pre-defined region of said data input device.

Typically, said system comprises means to fetch IP address of said data input device in order to determine location of said data input device.

Typically, said system comprising means to fetch IP address of said pre-registered user-owned electronic device in order to determine location of said pre-registered user-owned electronic device.

Typically, said system comprises rule creation engine adapted to allow an authorised user of said system to create rules of distance or perimeter or locus of points for locations for said pre-registered user-owned electronic device in relation to said data input device.

Additionally, said system comprises rule creation engine adapted to allow an authorised user of said system to create rules of distance or perimeter or locus of points for locations for said pre-registered user-owned electronic device, said rule creation engine being paired with a geographical location information server so that rules in relation to each pre-defined and pre-registered user-owned electronic device may be individually defined and stored.

Additionally, said system comprises rule creation engine adapted to allow an authorised user of said system to create rules of distance or perimeter or locus of points for creating awareness areas or awareness regions, wherein the awareness area or awareness regions is the area or region within which any transaction attempted by a data input device may be automatically validated by the system of the present invention.

Additionally, said system comprises rule creation engine adapted to allow an authorised user of said system to create rules of distance or perimeter or locus of points for locations for said pre-registered user-owned electronic device and said system further comprising means to receive or retrieve data from said rule creation engine to allow verifiable transactions, in accordance with rules in relation to each pre-defined and pre-registered user-owned electronic device.

Additionally, said system comprises rule creation engine adapted to allow an authorised user of said system to create rules of distance or perimeter or locus of points for locations for said data input device in relation to said pre-registered data input device.

Additionally, said system comprises rule creation engine adapted to allow an authorised user of said system to create rules of distance or perimeter or locus of points for locations for said data input device, said rule creation engine being paired with a geographical location information server so that rules in relation to each pre-defined and pre-registered user-owned electronic device may be individually defined and stored.

Additionally, said system comprises rule creation engine adapted to allow an authorised user of said system to create rules of distance or perimeter or locus of points for locations for said data input device and said system further comprising means to receive or retrieve data from said rule creation engine to allow verifiable transactions, in accordance with rules in relation to each pre-defined and pre-registered user-owned electronic device.

Additionally, said system comprises an overriding mechanism adapted to allow a user to override said system in cases of emergency or theft of said pre-registered user-owned electronic device.

Additionally, said system comprising an overriding mechanism adapted to allow a user to override said system in cases of emergency or theft, said overriding mechanism being a PIN verified overriding mechanism.

Additionally, said pre-registered user-owned electronic device comprises identifiers adapted to identify real-time geographical location, said identifiers being selected from a group of identifiers consisting of latitude and longitude of the place, the Global Positioning System (GPS), Global System for Mobile Communications (GSM), Internet Protocol (IP) Address, Automatic Identification System (AIS), Real-time locating systems (RTLS), triangulation systems, or any combination thereof.

Additionally, said system comprises a safety mode adapted to allow an authorised person to stop transactions in accordance with pre-determined levels or safety.

Preferably, said step of relaying real-time geographical location of a pre-registered user-owned electronic device comprises a step of relaying real-time geographical location of a mobile device.

Alternatively, said step of relaying real-time geographical location of a pre-registered user-owned electronic device comprises a step of relaying real-time geographical location of a mobile phone device.

Alternatively, said step of relaying real-time geographical location of a pre-registered user-owned electronic device comprises a step of relaying real-time geographical location of a pre-registered computing device.

Alternatively, said step of relaying real-time geographical location of a pre-registered user-owned electronic device comprises a step of relaying real-time geographical location of a pre-registered electronic device, by itself, or upon querying.

Alternatively, said step of relaying real-time geographical location of a data input device comprises a step of relaying real-time geographical location of the data input electronic device, by itself, or upon querying.

Alternatively, said step of relaying real-time geographical location of a pre-registered user-owned electronic device comprises a step of relaying real-time geographical location of a device selected from a group of electronic devices consisting of passive devices, active devices, or smart devices.

Alternatively, said method comprises a step of reading read signals from said pre-registered user-owned electronic device.

Alternatively, said step of relaying real-time geographical location of a pre-registered user-owned electronic device comprises a step of relaying real-time geographical location of a device with an embedded map-related application.

Typically, said method comprises a step of storing registration information comprising at least a device identity along with a correlated user identity, using a retrievable database.

Typically, said method comprises a step of remotely communicating with said pre-registered user-owned electronic device in order to receive or retrieve its real-time location, using a location information server, said location information server being adapted to communicate with said processing mechanism.

Typically, said method comprises a step of storing geographical location information of data input device adapted to be used by said user to transact, using a location information server, said location information server being adapted to communicate with said processing mechanism.

Alternatively, said method comprises a step of receiving or retrieving geographical location information of data input device adapted to be used by said user to transact, using a location information server, said location information server being adapted to communicate with said processing mechanism.

Typically, said step of validating a transaction, at said data input device comprising a step of pre-defining and pre-registering said data input device in terms of identity and location.

Typically, said functions of receiving and retrieving and comparing being performed by a processing mechanism comprises a step of comparing real-time pre-registered user-owned electronic device location with said location of said data input device where transaction is to be initiated in order to provide a confirmation of match in the event that said user, with said pre-registered user-owned electronic device, is within a pre-defined region of said data input device.

Typically, said method comprises a step of fetching IP address of said data input device in order to determine location of said data input device.

Typically, said method comprises a step of fetching IP address of said pre-registered user-owned electronic device in order to determine location of said pre-registered user-owned electronic device.

Typically, said method comprises a step of allowing an authorised user of said method to create rules of distance or perimeter or locus of points for locations for said pre-registered user-owned electronic device in relation to said pre-registered user-owned electronic device.

Additionally, said method comprises a step of allowing an authorised user of said system to create rules of distance or perimeter or locus of points for locations for said pre-registered user-owned electronic device, said rule creation engine being paired with a geographical location information server so that rules in relation to each pre-defined and pre-registered user-owned electronic device may be individually defined and stored.

Additionally, said method comprises a step of allowing an authorised user of said system to create rules of distance or perimeter or locus of points for creating awareness areas or awareness regions.

Additionally, said method comprises a step of allowing an authorised user of said system to create rules of distance or perimeter or locus of points for locations for said pre-registered user-owned electronic device and said system further comprising means to receive or retrieve data from a rule creation engine to allow verifiable transactions, in accordance with rules in relation to each pre-defined and pre-registered user-owned electronic device.

Additionally, said method comprises a step of allowing an authorised user of said system to create rules of distance or perimeter or locus of points for locations for said data input device in relation to said pre-registered user-owned electronic device.

Additionally, said method comprises a step of allowing an authorised user of said system to create rules of distance or perimeter or locus of points for locations for said data input device in relation to pre-defined and pre-registered user-owned electronic device, a rule creation engine being paired with a location information server so that said rules may be individually defined and stored.

Additionally, said method comprises a step of allowing an authorised user of said system to create rules of distance or perimeter or locus of points for locations for said data input device in relation to pre-defined and pre-registered user-owned electronic device and said system further comprising means to receive or retrieve data from said rule creation engine to allow verifiable transactions.

Additionally, said method comprises a step of allowing a user to override said system in cases of emergency or theft of said pre-registered user-owned electronic device, using an overriding mechanism.

Additionally, said method comprises a step of allowing a user to override said system in cases of emergency or theft, using an overriding mechanism, said overriding mechanism being a PIN verified overriding mechanism.

Additionally, said method comprises a step of providing identifiers for said pre-registered user-owned electronic device adapted to identify real-time geographical location, said identifiers being selected from a group of identifiers consisting of latitude and longitude of the place, the Global Positioning System (GPS), Global System for Mobile Communications (GSM), Internet Protocol (IP) Address, Automatic Identification System (AIS), Real-time locating systems (RTLS), triangulation systems, or any combination thereof.

Additionally, said method comprises a step of allowing an authorised person to stop transactions in accordance with pre-determined levels or safety.

### BRIEF DESCRITION OF THE ACCOMPANYING DRAWINGS

The invention will now be described in relation to the accompanying drawings, in which:

FIG. 1 illustrates an example of a schematic of the system for validating monetary transaction using location information of a user;

FIG. 2 illustrates an example of a schematic of the system of FIG. 1 which defines various perimeters, awareness areas, or awareness regions;

FIG. 3a represents a schematic illustration of an overlapping or positive match situation according to the method of this invention (Here, transaction is approved); and

FIG. 3b represents a schematic illustration of a non-overlapping or negative match situation according to the method of this invention (Here, transaction is not approved).

### DETAILED DESCRITION OF THE ACCOMPANYING DRAWINGS:

According to this invention, there is provided a system and method for validating monetary transaction using location information of a user.

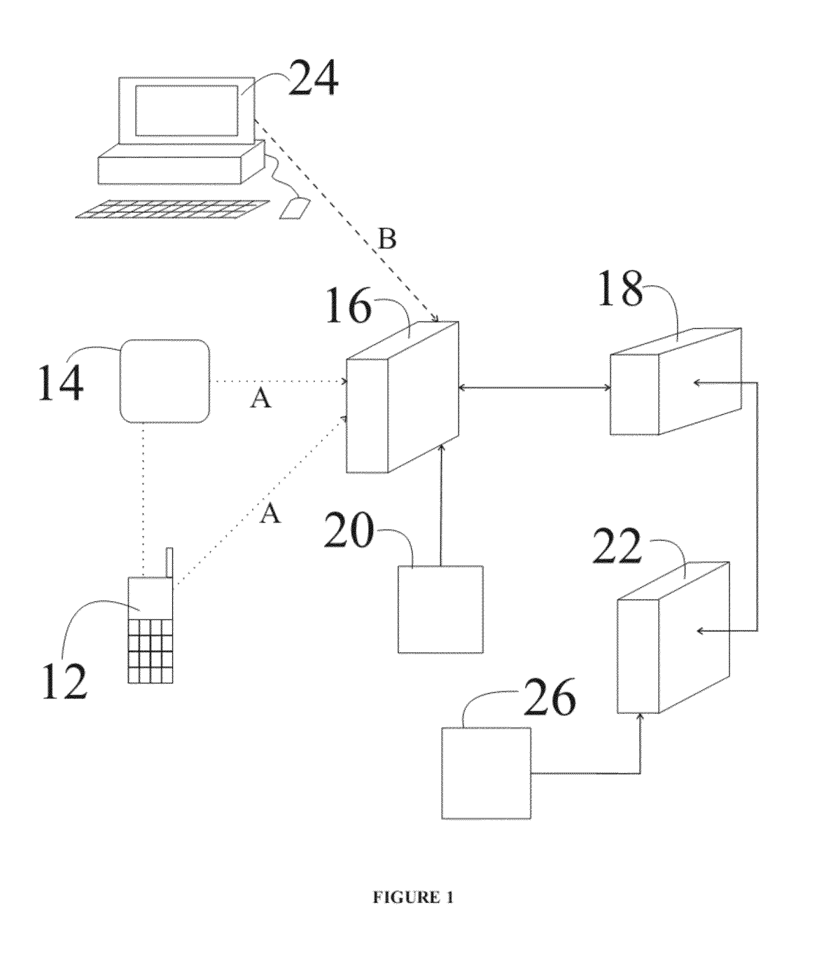

FIG. 1 illustrates a schematic of an exemplary embodiment of the system.

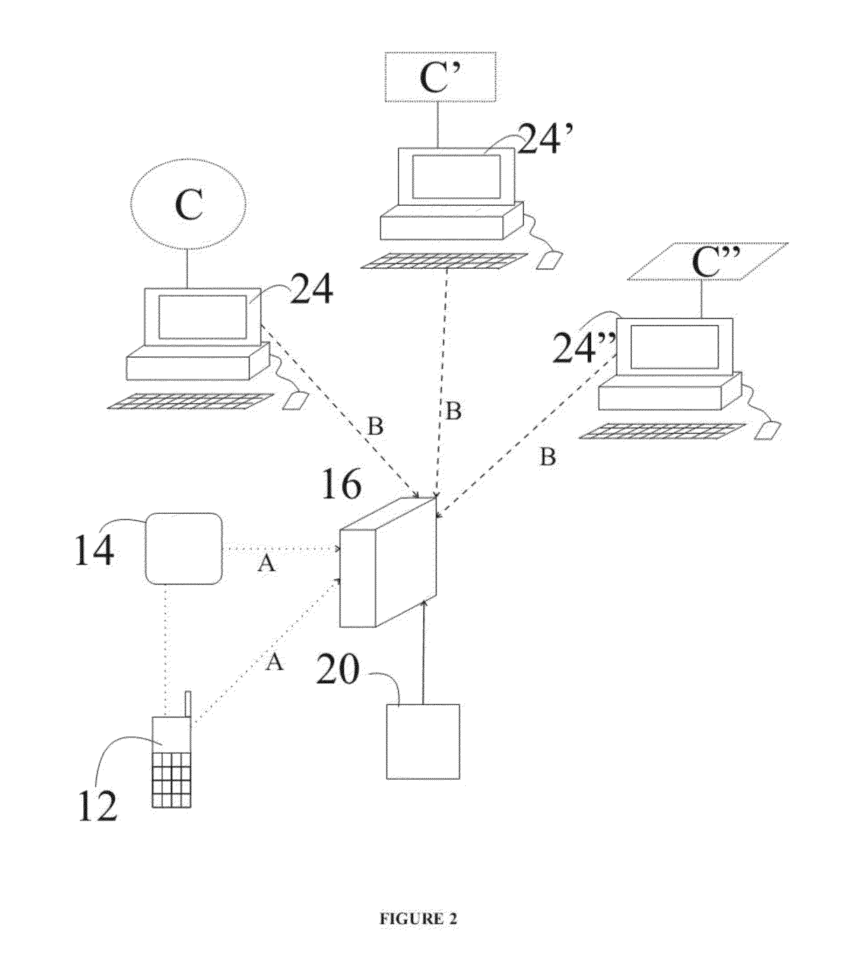

FIG. 2 illustrates a schematic of an exemplary embodiment of the system of FIG. 1 which defines various perimeters, awareness areas, or awareness regions.

In accordance with an embodiment of this invention, there is provided a pre-registered user-owned electronic device (12) adapted to relay its real-time geographical location to a remotely located mechanism or system or its part thereof. This pre-registered user-owned electronic device (12) may be a mobile device such as mobile phone or merely a mobile locating device or maybe a computing device such as a laptop, a netbook, or any other device adapted to relay its real-time geographic location, by itself, or upon querying. According to one embodiment, the user is intended to carry the pre-registered user-owned electronic device (12), on person, whilst effecting the transaction. According to another embodiment, the user may not carry the pre-registered electronic user-owned device, on person, whilst effecting the transaction. The pre-registered electronic user-owned device (12) needs to be pre-registered with the system of this invention, in that, the identity, preferably, a unique device identity along with a correlated user identity is stored in a secure retrievable database. The device identity information is stored remotely and is used in order to fetch device location as and when required by the system and method of this invention. The pre-registered user-owned electronic device (12) may be a passive device, an active device, or a smart device. A passive device does not send out any signals. In case of its proximity to a reader, a passive device's information is fetched by a reader (14) and transmitted. An active device constantly emits signals. A smart device only sends signals only when queried by a reader (14) in proximity. These signals are geographic information related signals. The pre-registered electronic user-owned device (12) may be any mobile phone with a map-related application embedded on it. Alternatively, the pre-registered user-owned electronic device (12) may be a computer adapted to relay its IP address in order to determine its location.

In accordance with another embodiment of this invention, there is provided a location information server (16) adapted to remotely communicate with the pre-registered user-owned electronic device (12). The location information server (16) is adapted to store location information of data input devices (24), kiosks, apparatus, systems, devices, and the like which are used by a user to transact. The data input devices, kiosks, apparatus, systems, devices, and the like are reference by numeral 24. These locations are pre-defined and registered. The data input device (24) comprises a data input device or means which facilitate data input for effecting the transaction.

For the purposes of this invention, the term, “data input device” is adapted to mean any system, method, device, kiosk, POS terminal, swipe means, apparatus, or its combinations which allow a user to effect or actuate a commercial transaction.

Reference numeral A refers to location information of pre-registered user-owned electronic device (12). Reference numeral B refers to location information of data input device (24).

In accordance with yet another embodiment of this invention, there is provided a processing mechanism (18) adapted to receive or retrieve real-time pre-registered user-owned electronic device (12) location and is further adapted to fetch location information of a data input device, kiosks (24), apparatus, systems, devices, and the like where a user wishes to initiate a transaction. The processing mechanism (18) includes comparators adapted to compare the real-time pre-registered electronic device (12) location with the location of the data input device (24), kiosks, apparatus, systems, devices, and the like where transaction is to be initiated in order to provide a confirmation of match in the event that the user (with the pre-registered electronic device (12)) is within a pre-defined region of the data input device (24), kiosks, apparatus, systems, devices, and the like. The location of the data input device (24), kiosks, apparatus, systems, devices, and the like may be figured through its IP address.

In accordance with still another embodiment of this invention, there is provided a rule creation engine (20) adapted to allow an authorised user of the system to create rules for authentication. The rules may be in terms of distances or perimeters or the like parameters. The rule creation engine (20) is paired with the processing mechanism (18) so that rules in relation to each pre-defined and pre-registered data input device (24), kiosks, apparatus, systems, devices, and the like may be individually defined. It may be paired with the location information server (16). According to a non-limiting exemplary embodiment, for a small retail store hosting a data input device (24), a rule of perimeter for matching pre-registered user-owned electronic device (12) location and data input device (24) location may not be more than a few metres. According to another non-limiting exemplary embodiment, for a mall hosting several data input device (24), a rule of perimeter for matching pre-registered user-owned electronic device (12) location and data input device location may be extended to a few hundred metres. The rule creation engine (20) sets the tolerance level / accuracy level for matching the locations read from the pre-registered user-owned electronic device (12) with the location of the data input device.

Reference numerals C, C′, C″ refer to various perimeters defined by the rule creation engine (20) in relation to corresponding data input device (24, 24′, 24″). These perimeters can also be termed as awareness areas or awareness regions.

In accordance with an additional embodiment of this invention, there is provided a transaction validation server (22) adapted to validate a transaction upon receiving a positive confirmation of match from a processing mechanism (18). The transaction validation server (22) authenticates the transaction effected at the data input device (24), kiosks, apparatus, systems, devices, and the like. The transaction validation server (20) considers data from rule creation engine (20) to allow verifiable and / or authenticated transactions, in accordance with rules in relation to each data input device (24), kiosks, apparatus, systems, devices, and the like.

In accordance with yet an additional embodiment of this invention, there is provided an overriding mechanism (26). This may be a PIN verified overriding mechanism. In the event that the pre-registered user-owned electronic device (12) is lost, a user may be able to still carry out transactions by activating the overriding mechanism (26).

In an embodiment of the invention, the geographical location information of a user or a pre-registered user-owned electronic device may be identified from various identifiers such as but not limited to the latitude and longitude of the place, the Global Positioning System (GPS), Global System for Mobile Communications (GSM), Internet Protocol (IP) Address, Automatic Identification System (AIS), Real-time locating systems (RTLS), triangulation systems, or any combination thereof

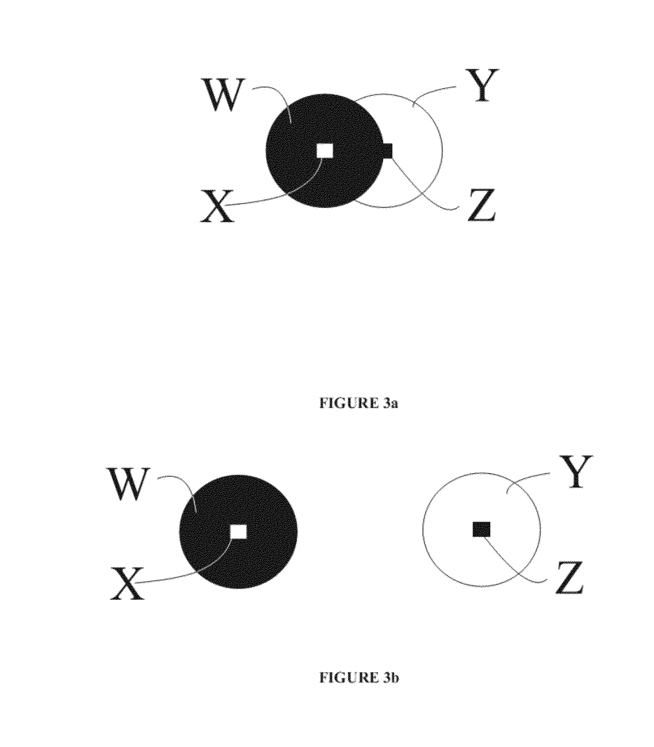

FIG. 3a represents a schematic illustration of an overlapping or positive match situation according to the method of this invention (Here, transaction is approved). FIG. 3b represents a schematic illustration of a non-overlapping or negative match situation according to the method of this invention (Here, transaction is not approved).

Reference numeral W refers to location of data input device (transacting device such as point of sale or IP address) as per location information server. Reference numeral X refers to location of data input device (transacting device such as point of sale at a mall). Reference numeral Y refers to location of pre-registered user-owned electronic device as per location information server. Reference numeral Z refers to location of pre-registered user-owned electronic device (such as GPS of a mobile).

A user is any person, machine or software that uses or accesses one or more of the systems or methods of the present invention. A user includes an automated computer program and a machine.

In an embodiment of the invention, the systems and methods of the invention may simultaneously involve more than one user or more than one data storage device or more than one transaction validation server or more than one location information server or any combination thereof

In an embodiment of the invention, it may be required that the electronic device may meet certain predetermined parameters such as but not limited to having licensed version of software or operating system of the device, or an original device itself

In an embodiment of the invention, a data input device may include but not limited to an electronic device, a pdq (Process Data Quickly) terminal, ATM (Automatic Teller Machine) terminal, a keypad, a stationary telephone (landline), a mobile phone, a keyboard, a mouse, a joystick, a touchpad, a virtual keyboard, a graphical user interface, a virtual dial pad, a software or a program, a scanner, a remote device, a microphone, a webcam, a camera, a fingerprint scanner, a VR type input device such as used in cave, pointing stick, magnetic strip reader/scanner, chip reader, RFID reader/scanner, or any combination thereof

In an embodiment of the invention, the systems and methods of the invention may allow a user to register or deregister one or more electronic devices at anytime.

In an embodiment of the invention, a user may control disabling or deleting geographical location information of one or more user-owned electronic device which may have been pre-registered which may further control validation or rejection of a monetary transaction.

In an embodiment of the invention, geographical location information or data may be stored or processed or exchanged in encrypted or coded or encoded or scrambled or translated or ciphered form.

In an embodiment of the invention, the systems and methods can be practised using any electronic device which may be connected to one or more of other electronic device with wires or wirelessly which may use technologies such as but not limited to, Bluetooth, WiFi, Wimax. This will also extend to use of the aforesaid technologies to provide an authentication key or access key or electronic device based unique key or any combination thereof

In an embodiment of the invention, the systems of the invention may be accessed through a website or a network based application or a plugin or independent software programs.

For the purpose of this invention the term ‘data storage device’ may include but is not limited to server, computer, laptop, CDs, DVDs, floppy disks, hard disk drives, digital tape, or any combination thereof. Data from one or more sources may be stored in the said data storage device, wherein the sources may include but is not limited to one or more databases, data provided by user, data provided by an operator of the invention other than the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

The process steps, method steps, protocols, algorithms or the like may be described in a sequential order, such processes, methods, protocol and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

Furthermore, this invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout the description of the figures. It will be understood that when an element is referred to as being “connected” or “coupled” to another element, it can be directly connected or coupled to the other element or intervening elements may be present. In contrast, when an element is referred to as being “directly connected or coupled” to another element, there are no intervening elements present. Furthermore, “connected” or “coupled” as used herein may include wirelessly connected or coupled. As used herein, the term “and/or” includes any and all combinations of one or more of the associated listed items.

The aim of this specification is to describe the invention without limiting the invention to any one embodiment or specific collection of features. Person skilled in the relevant art may realize the variations from the specific embodiments that will nonetheless fall within the scope of the invention.

It may be appreciated that various other modifications and changes may be made to the embodiment described without departing from the spirit and scope of the invention.

I claim,:

1. A system for validating monetary transaction using location information of a user, wherein the system comprises,
a) a transaction validation server;
b) a location information server;
c) a data input device; and
d) a processing mechanism;
wherein, a user shall provide transaction information using the data input device and the geographical location information of the data input device which is already stored in the location information server shall be compared against the geographical location information of a pre-registered user-owned electronic device, and wherein the geographical location information of a pre-registered user-owned electronic device is also stored in the location information server and based on the comparative results of the processing mechanism the transaction validation server shall validate or invalidate a monetary transaction.

2. A system as claimed in claim 1, wherein said pre-registered user-owned electronic device is selected from a group comprising mobile device, mobile phone device, mobile locating device, pre-registered computing device, passive devices, active devices, smart devices, and any combination thereof.

3. A system as claimed in claim 1, wherein said pre-registered user-owned electronic device is electronic device adapted to relay its real-time geographic location information, by itself, or upon querying.

4. A system as claimed in claim 1, wherein said system comprising a reader adapted to read signals from said pre-registered user-owned electronic device.

5. A system as claimed in claim 1, wherein said pre-registered user-owned electronic device is a device with an embedded map-related application.

6. A system as claimed in claim 1, wherein said system comprising a retrievable database adapted to store registration information comprising at least a device identity along with a correlated user identity.

7. A system as claimed in claim 1, wherein said system comprising a location information server adapted to remotely communicate with said pre-registered user-owned electronic device in order to receive or retrieve its real-time location, said location information server being adapted to communicate with said processing mechanism.

8. A system as claimed in claim 1, wherein said system comprising a location information server adapted to store location information of data input device adapted to be used by said user to transact, said location information server being adapted to communicate with said processing mechanism.

9. A system as claimed in claim 1, wherein said system comprising a location information server adapted to receive or retrieve location information of data input device adapted to be used by said user to transact, said location information server being adapted to communicate with said processing mechanism.

10. A system as claimed in claim 1, wherein said processing mechanism comprising comparators adapted to compare said real-time pre-registered user-owned electronic device location with said location of said data input device where transaction is to be initiated in order to provide a confirmation of match in the event that said user, with said pre-registered electronic device, is within a pre-defined region of said data input device.

11. A system as claimed in claim 1, wherein said system comprising means to fetch IP address of said data input device in order to determine geographical location of said data input device.

12. A system as claimed in claim 1, wherein said system comprising means to fetch IP address of said pre-registered user-owned electronic device in order to determine location of said pre-registered user-owned electronic device.

13. A system as claimed in claim 1, wherein said system comprising rule creation engine adapted to allow an authorised user of said system to create rules of distance or perimeter or locus of points for locations for said pre-registered user-owned electronic device in relation to said pre-registered user-owned electronic device.

14. A system as claimed in claim 1, wherein said system comprising rule creation engine adapted to allow an authorised user of said system to create rules of distance or perimeter or locus of points for locations for said pre-registered user-owned electronic device, said rule creation engine being paired with a location information server so that rules in relation to each pre-defined and pre-registered user-owned electronic device may be individually defined and stored.

15. A system as claimed in claim 1, wherein said system comprising rule creation engine adapted to allow an authorised user of said system to create rules of distance or perimeter or locus of points for creating awareness areas or awareness regions.

16. A system as claimed in claim 1, wherein said system comprising rule creation engine adapted to allow an authorised user of said system to create rules of distance or perimeter or locus of points for locations for said pre-registered user-owned electronic device and said system further comprising means to receive or retrieve data from said rule creation engine to allow verifiable transactions, in accordance with rules in relation to each pre-defined and pre-registered user-owned electronic device.

17. A system as claimed in claim 1, wherein said system comprising rule creation engine adapted to allow an authorised user of said system to create rules of distance or perimeter or locus of points for locations for said data input device in relation to said pre-registered user-owned electronic device.

18. A system as claimed in claim 1, wherein said system comprising rule creation engine adapted to allow an authorised user of said system to create rules of distance or perimeter or locus of points for locations for said data input device in relation to pre-registered user-owned electronic device, said rule creation engine being paired with a location information server so that rules are individually defined and stored.

19. A system as claimed in claim 1, wherein said system comprising rule creation engine adapted to allow an authorised user of said system to create rules of distance or perimeter or locus of points for locations for said data input device in relation to pre-registered user-owned electronic device and said system further comprising means to receive or retrieve data from said rule creation engine to allow verifiable transactions.

20. A system as claimed in claim 1, wherein said system comprising an overriding mechanism adapted to allow a user to override said system in cases of emergency or theft of said pre-registered user-owned electronic device.

21. A system as claimed in claim 1, wherein said system comprising an overriding mechanism adapted to allow a user to override said system in cases of emergency or theft, said overriding mechanism being a PIN verified overriding mechanism.

22. A system as claimed in claim 1, wherein said pre-registered user-owned electronic device comprising identifiers adapted to identify real-time geographical location, said identifiers being selected from a group of identifiers consisting of latitude and longitude of the place, the Global Positioning System (GPS), Global System for Mobile Communications (GSM), Internet Protocol (IP) Address, Automatic Identification System (AIS), Real-time locating systems (RTLS), triangulation systems, and any combination thereof

23. A system as claimed in claim 1, wherein said system comprising a safety mode adapted to allow an authorised person to stop transactions in accordance with pre-determined levels or safety.

24. A method for validating monetary transaction using location information of a user, comprises the steps of,
a) providing transaction information by a user using a data input device;
b) retrieving or relaying geographical location information of the data input device from the stored information in the location information server;
c) retrieving or relaying geographical location information of a pre-registered user-owned electronic device;
d) storing of geographical location information of the data input device in the location information server;
e) storing of geographical location information of the pre-registered user-owned electronic device in the location information server;
f) matching the retrieved geographical location information of the data input device with the retrieved geographical location information of the pre-registered user-owned electronic device by a processing mechanism; and
g) validating or invalidating a monetary transaction by a transaction validation server based on the comparative result of the geographical location information of the data input device and the pre-registered user-owned electronic device;
wherein the data input device and the pre-registered user-owned electronic device may be same or different.

25. A method as claimed in claim 24, wherein said step of relaying real-time geographical location of a pre-registered user-owned electronic device comprising a step of relaying real-time geographical location of said pre-registered user-owned electronic device selected from a group comprising a mobile device, mobile phone device, a mobile locating device, computing device, and any combination thereof

26. A method as claimed in claim 24, wherein said step of relaying real-time geographical location of a pre-registered electronic device comprising a step of relaying real-time geographical location of a pre-registered user-owned electronic device, by itself, or upon querying.

27. A method as claimed in claim 24, wherein said step of relaying real-time geographical location of a pre-registered electronic device comprising a step of relaying real-time geographical location of a device selected from a group of pre-registered user-owned electronic devices consisting of passive devices, active devices, or smart devices.

28. A method as claimed in claim 24, wherein said method comprising a step of reading read signals from said pre-registered user-owned electronic device.

29. A method as claimed in claim 24, wherein said step of relaying real-time geographical location of a pre-registered user-owned electronic device comprising a step of relaying real-time geographical location of a device with an embedded map-related application.

30. A method as claimed in claim 24, wherein said method comprising a step of storing registration information comprising at least a device identity along with a correlated user identity, using a retrievable database .

31. A method as claimed in claim 24, wherein said method comprising a step of remotely communicating with said pre-registered user-owned electronic device in order to receive or retrieve its real-time location, using a location information server, said location information server being adapted to communicate with said processing mechanism.

32. A method as claimed in claim 24, wherein said method comprising a step of storing location information of data input device adapted to be used by said user to transact, using a location information server, said location information server being adapted to communicate with said processing mechanism.

33. A method as claimed in claim 24, wherein said method comprising a step of receiving or retrieving location information of data input device adapted to be used by said user to transact, using a location information server, said location information server being adapted to communicate with said processing mechanism.

34. A method as claimed in claim 24, wherein said step of validating a transaction, at said data input device comprising a step of pre-defining and pre-registering said data input device in terms of identity and location.

35. A method as claimed in claim 24, wherein said functions of receiving and retrieving and comparing being performed by a processing mechanism comprising a step of comparing real-time pre-registered user-owner electronic device location with said location of said data input device where transaction is to be initiated in order to provide a confirmation of match in the event that said user, with said pre-registered user-owner electronic device, is within a pre-defined region of said data input device.

36. A method as claimed in claim 24, wherein said method comprising a step of fetching IP address of said data input device in order to determine location of said data input device.

37. A method as claimed in claim 24, wherein said method comprising a step of fetching IP address of said pre-registered user-owner electronic device in order to determine location of said pre-registered user-owner electronic device.

38. A method as claimed in claim 24, wherein said method comprising a step of allowing an authorised user of said method to create rules of distance or perimeter or locus of points for locations for said pre-registered user-owner electronic device in relation to said pre-registered user-owner electronic device.

39. A method as claimed in claim 24, wherein said method comprising a step of allowing an authorised user of said system to create rules of distance or perimeter or locus of points for locations for said pre-registered user-owner electronic device, said rule creation engine being paired with a location information server so that rules in relation to each pre-defined and pre-registered user-owner electronic device may be individually defined and stored.

40. A method as claimed in claim 24, wherein said method comprising a step of allowing an authorised user of said system to create rules of distance or perimeter or locus of points for creating awareness areas or awareness regions.

41. A method as claimed in claim 24, wherein said method comprising a step of allowing an authorised user of said system to create rules of distance or perimeter or locus of points for locations for said pre-registered user-owner electronic device and said system further comprising means to receive or retrieve data from a rule creation engine to allow verifiable transactions, in accordance with rules in relation to each pre-defined and pre-registered user-owner electronic device.

42. A method as claimed in claim 24, wherein said method comprising a step of allowing an authorised user of said system to create rules of distance or perimeter or locus of points for locations for said data input device in relation to said pre-registered user-owner electronic device.

43. A method as claimed in claim 24, wherein said method comprising a step of allowing an authorised user of said system to create rules of distance or perimeter or locus of points for locations for said data input device, a rule creation engine being paired with a location information server so that rules in relation to each pre-defined and pre-registered user-owner electronic device may be individually defined and stored.

44. A method as claimed in claim 24, wherein said method comprising a step of allowing an authorised user of said system to create rules of distance or perimeter or locus of points for locations for said data input device and said system further comprising means to receive or retrieve data from said rule creation engine to allow verifiable transactions, in accordance with rules in relation to each pre-defined and pre-registered user-owner electronic device.

45. A method as claimed in claim 24, wherein said method comprising a step of allowing a user to override said system in cases of emergency or theft of said pre-registered user-owner electronic device, using an overriding mechanism.

46. A method as claimed in claim 24, wherein said method comprising a step of allowing a user to override said system in cases of emergency or theft, using an overriding mechanism, said overriding mechanism being a PIN verified overriding mechanism.

47. A method as claimed in claim 24, wherein said method comprising a step of providing identifiers for said pre-registered user-owner electronic device adapted to identify real-time geographical location, said identifiers being selected from a group of identifiers consisting of latitude and longitude of the place, the Global Positioning System (GPS), Global System for Mobile Communications (GSM), Internet Protocol (IP) Address, Automatic Identification System (AIS), Real-time locating systems (RTLS), triangulation systems, and any combination thereof.

48. A method as claimed in claim 24, wherein said method comprising a step of allowing an authorised person to stop transactions in accordance with pre-determined levels or safety.

49. A method as claimed in claim 24, wherein the data input device and the pre-registered user-owned electronic device are same.

50. A method as claimed in claim 24, wherein data the input device and the pre-registered user-owned electronic device are different.
